(19) United States
(12) Patent Application Publication
(10) Pub. No.: US 2008/0043809 A1
(43) Pub. Date: Feb. 21, 2008

(54) Thermometer

(76) Inventor: Curtis B. Herbert, St. Paul, MN (US)

Correspondence Address: DARDI & ASSOCIATES, PLLC, 220 S. 6TH ST., SUITE 2000, U.S. BANK PLAZA, MINNEAPOLIS, MN, 55402, US

(21) Appl. No.: 11/595,722

(22) Filed: Nov. 9, 2006

Related U.S. Application Data
(60) Provisional application No. 60/838,292, filed on Aug. 18, 2006.
(60) Provisional application No. 60/841,048, filed on Aug. 30, 2006.

(51) Int. Cl. G01K 7/00

(52) U.S. Cl. 374/163

(57) ABSTRACT

Certain embodiments of the invention are temperature probes that have an outer sheathing that contains a plurality of electronic temperature sensors disposed to measure temperature at distinct portions of the probe. Uses of such probes include measuring temperature profiles of objects during cooking or grilling.

### RELATED APPLICATIONS

This Application claims priority to U.S. Pat. Ser. Nos. 60/838,292 filed Aug. 18, 2006 and 60/841,048 Aug. 30, 2006, which are hereby are incorporated by reference herein.

### TECHNICAL FIELD

The technical field of the invention relates to improved thermometers, particularly thermometers having an electronic temperature sensor.

### BACKGROUND

Cooking thermometers are popular accessories for cooks, especially grilling enthusiasts. Some cooking thermometers use a bimetallic strip that changes shape with changing temperature to move a pointer on a dial and thereby indicate a temperature. Other thermometers report temperatures on a liquid crystal display (LCD). For example, U.S. Pat. No. 6,811,308 describes a wireless remote cooking thermometer system that transmits temperature information from a thermometer to a remote unit and provides an audible alarm when a desired temperature is reached. And U.S. Pat. No. 5,983,783 describes an electronic chef's fork having one temperature sensor located in one tine.

### SUMMARY

Such descriptions, however, do not address the problem that cooking thermometers often do not provide an accurate temperature because they are not placed accurately in meat. An accurate placement would cause the detector of the thermometer probe to be placed in the center of the meat to detect a temperature where the temperature is lowest. Cooks wish to know the lowest temperature because meat cooking is typically performed to obtain a minimum temperature in the approximate center of a piece of meat. The detector tip of a thermometer probe, however, often must be advanced a few centimeters into a piece of meat, at which point its location is a matter of guesswork to the user, who cannot see the tip and who often does not accurately know how far into the meat the probe has been placed. Further, probe placement is often done under adverse conditions, as in on a hot grill or near a hot oven.

Thus it would be helpful to have a thermometer that provides an accurate temperature at the center of a piece of meat even if the thermometer probe is not placed with precision. This problem is solved by certain thermometers described herein. In fact, a thermometer probe with a plurality of temperature sensors can be used in combination with a processor to determine the lowest temperature in an object; a user cannot know exactly where the temperature probe is located, but the processor can tell the user what the lowest temperature is that is encountered by the probe. The probe-and-processor combination can compensate for the user's inability to place the tip of the probe in exactly the right spot because it can help the user identify the temperature of the spot they are trying to measure.

One thermometer embodiment uses multiple detectors on a single probe that is connected to a processor that provides the lowest detected temperature to a display. As shown in FIG. 1, even if the distal-most tip of the probe is not placed with particular accuracy, the logical unit can sample a plurality of temperatures and display the lowest temperature. Other thermometers are described herein with a scale engraved on a probe to indicate the distance of insertion of the probe.

Some methods disclosed herein relate to a method of obtaining a temperature using a self-inserting temperature probe that has at least tine (that optionally has a point) by inserting the point of the tine of the self-inserting temperature probe into an object, (with the tine optionally having an outer sheathing made from material with a melting point of at least 300° C.); heating the object with an external energy source, e.g., cooking a food item; measuring temperatures within the heated object at distinct positions of the tine with a plurality of electronic temperature sensors disposed as a linear array in the tine; and comparing the measured temperatures with each other using a processor that outputs a result of the comparison to a display on a hand-held unit. Displaying the processed temperature data on the display may include indicating on the display the lowest measured temperature.

Other methods include making a thermometer for measuring temperatures within an object, e.g., a food item that is to be cooked, comprising placing a plurality of electronic temperature sensors in a linear array in a temperature probe tine optionally having an outer sheathing with a melting point of at least 300° C. The method may further include connecting the sensors to a processor for processing the temperature data and for displaying at least a portion of the processed temperature data for the temperatures measured within the object on a display of a hand-held unit.

Embodiments of a thermometer system include a hand-held temperature probe that comprises a tine made of an outer sheathing material, the tine containing a plurality of electronic temperature sensors disposed in a linear array to measure temperature at distinct portions of the tine; a processor, e.g., for comparing the measured temperatures with each other; and a hand-held unit to display at least one of the measured temperatures, e.g., after comparing the measured temperatures with each other. Such a probe may be, for instance, rigid with a pointed tip.

### BRIEF DESCRIPTION OF THE FIGURES

FIG. 1 is a cross-sectional view of an electronic thermometer with a probe having multiple temperature sensors placed in a piece of meat;

FIG. 2 is a cross-sectional view of a probe with a plurality of temperature sensors;

FIG. 3 is an elevated view of an exterior surface of a probe with a plurality of exterior surface materials;

FIG. 4 is a cross-sectional view of a probe with a plurality of temperature sensors disposed in a piece of meat;

FIG. 5 is an elevated view of the probe of FIG. 4;

FIG. 6 is a cross-sectional elevated view of an alternative embodiment;

FIG. 7 is an elevated view of a probe having a plurality of length indicia indicating a distance from the distal (pointed) tip of the probe;

FIG. 8 is an elevated view of a display for a thermometer; and

FIG. 9 depicts a thermometer system used to generate and display a temperature profile in an object.

### DETAILED DESCRIPTION OF PREFERRED EMBODIMENTS

Improved thermometers are described herein. In certain embodiments, a cooking thermometer that shows an accurate meat temperature for a center of a piece of meat has a probe that provides a temperature at each of a plurality of points on the probe. The thermometer system in certain embodiments has a processor to select the lowest temperature returned from the probe and display that temperature.

In some embodiments, a heat detector such as an electronic temperature sensor is placed at each of a plurality of points on a probe to determine a temperature from each point simultaneously, or relatively close in time, e.g., within less than a predetermined period of time, e.g., less than 60 seconds, 30 seconds, 10 seconds, 5 seconds, 1 second, or 0.1 seconds; artisans will immediately appreciate that every value and range within the explicitly stated ranges is are contemplated.

A temperature sensor, in the context of a temperature probe, is disposed to provide temperature information. The sensors in the temperature probe are equipped with the appropriate connections to provide information from the sensors to a display or to a processor. The temperature probe may be incorporated into a thermometer. Thus a metal that is merely heat-conductive but lacks the connections to provide temperature temperature sensors; the probes are ready to be attached to a device that can transform electrical signals from the temperature sensors into temperature information. And some embodiments are directed to a temperature probe that has a plurality of temperature sensors, with the sensors being configured to provide temperature information. For example, a probe may have a plurality of thermocouples or thermistors attached to wires that may be interfaced to another device that receives electrical information from the sensors and uses the information in relation to temperature measurements. A temperature sensor in a temperature probe measures the temperature at a particular portion of the probe. Two such sensors placed at different positions measure different temperatures, and thus measure temperature at distinct portions of the probe.

An electronic temperature sensor changes its electrical properties in response to a change in temperature so that measurement of its electrical properties provides information about the temperature at the sensor. Electronic temperature sensors are coupled to an apparatus that provides a temperature to a user or an intermediate output to another device that uses the information as it relates temperature. Electronic temperature sensors may include, e.g., thermistors (thermoresistors), thermocouples, sensors for resistance temperature detectors (RTDs) and silicon bandgap temperature sensors. A silicon bandgap temperature sensor is a common form of temperature sensor used in electronic equipment; one advantage is that it can be readily included in a silicon integrated circuit.

A thermistor is a type of resistor used to measure temperature changes by relying on the change in the thermistor's resistance with changing temperature. In general, thermistors can be classified into two types; a positive temperature coefficient (PTC) thermistor wherein resistance increases with increasing temperature or a negative temperature coefficient (NTC) thermistor wherein the resistance decreases with increasing temperature. Resistors that are not thermistors are typically designed to have a resistance that remains almost constant over a wide temperature range. Many NTC thermistors are made from a pressed disc or cast chip of semiconducting material such as a sintered metal oxide. There are many different semiconducting thermistors. When a current flows through a thermistor, it may generate heat which will raise the temperature of the thermistor above that of its environment. If the thermistor is being used to measure the temperature of the environment, this self-heating effect may introduce an error if a correction is not made. Such corrections are known in these arts and are conventionally made for use of the thermistor in a thermometer that returns a temperature of the object being probed.

Resistance temperature detectors (RTDs) operate on the principle of changes in electrical resistance of pure metals and are characterized by a linear positive change in resistance with temperature. Wire-wound RTDs are constructed by winding a thin wire into a coil. Another configuration is the thin-film element, which is a thin layer of metal laid out on a plastic or ceramic substrate. Typical elements used for RTDs include, e.g., nickel, copper, and platinum.

A thermocouple is a type of temperature sensor that can be used to convert a thermal potential difference into an electric potential difference. A conductor (such as a metal) subjected to a thermal gradient will generate a voltage, a phenomenon referred to as the thermoelectric effect. Measuring this voltage necessarily involves connecting an additional conductor to the first conductor. This additional conductor will then also experience the temperature gradient, and develop a voltage that will oppose the original. The magnitude of the effect depends on the metal. Using a dissimilar metal to complete the circuit will have a different voltage generated, leaving a small difference voltage available for to measure, which increases with temperature. Thermocouples are inexpensive, frequently interchangeable, often have standard connectors, and can measure a wide range of temperatures. Many thermocouples are known, and many are designated by letters such as J, E, K, N, B, R, S, or T.

The choice of temperature sensor or electronic temperature sensor may be made to suit the intended application. While the food industry is the example used for many of the embodiments disclosed herein, the inventive concepts are intended to be generally applicable to other industries.

Techniques for using a temperature sensor to measure a temperature are well known. Artisans may use any of a variety of techniques to use temperature sensors to display a temperature on a display or to provide temperature input to another device of software program; further, components for operating conventional thermometers have been described, including thermistors used to measure a temperature, temperature displays for cooking thermometers, wireless transmitters and receivers, programmable controllers such as display units, certain programming and information processing considerations, and various probes, e.g., see U.S. Pat. Nos. 3,552,210, 3,882,711, 4,068,526, 4,068,526, 4,580,909, 4,602,871, 5,282,685, 5,655,305, 5,983,783, 6,539,842, 6,546,846, 6,811,308, 6,893,155, 7,102,107, 7,075,442, in U.S. Pat. Ser. Nos. 10/091,013 and 09/884,032, and in U.S. Pat. Pub. No. 2002/0124737, each of which is hereby incorporated by reference herein to the extent it does not contradict the explicit disclosure of the specification. A probe of a thermometer is a device that is placed into an object to measure its temperature. In the case of a cooking thermometer, the probe is conventionally a hollow metal tube with a sharp point on its distal end. A thermistor, when used in such a device, is essentially located at the distal end in conventional temperature probes.

A probe with a plurality of temperature sensors may advantageously be used to measure temperatures in an object. The probe may be, e.g., hand-held, and, e.g., may have a weight of less than about 1 pound, or less than about one-half pound. A thermometer incorporating the probe may also be, e.g., hand-held and may, e.g., have a weight of less than about 1 pound, or less than about one-half pound. The thermometer may further comprise paging units or other remote units, as described below. A display unit may be a hand-held unit. The term hand-held unit means that it has a size and weight that can be conveniently held in one hand of a user, even if the user is not actually holding the object. In contrast, desktop personal computers are not hand-held display units. In the case of a cooking thermometer, a user can hold the hand-held unit and conveniently refer to it during the cooking process.

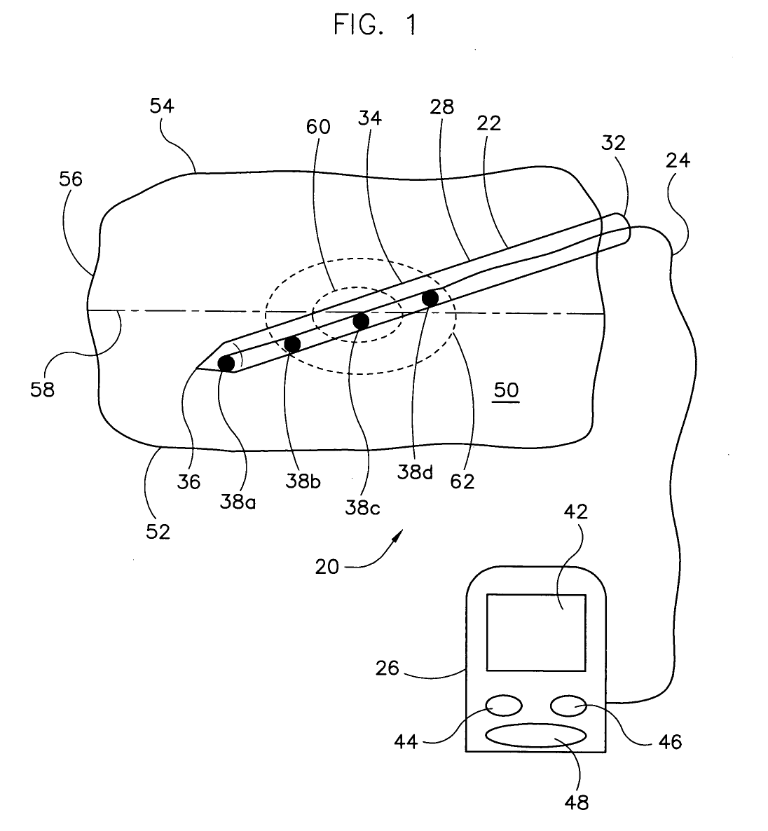

Referring to FIG. 1, thermometer system 20 has probe 22 connected via lead 24 to hand-held display unit 26. Probe 22 has sheath 28 with a proximal portion 32, distal portion 34 with pointed distal tip 36 and temperature sensors 38a, 38b, 38c, 38d. Display unit 26 has display 42 and buttons 44, 46, 48. As depicted, probe 22 is disposed in a piece of meat 50 having bottom 52 on a cooking surface (not shown), opposing top 54, thickness 56, midline 58 extending midway between bottom 52 and top 54, center region 60, and mid-region 62. In use, a user places pushes probe 22 into meat 50 by forcing distal tip 36 through meat 50. Forcing refers to applying a force to insert a probe to create a space in the object; such a probe is self-inserting. In contrast, using a catheter or syringe to create an opening in the object and then introducing a probe into the opening is not forcing, as that term is used herein; and such a probe is not self-inserting since an introducer is used to place it. A self-inserting probe is a probe that can be introduced directly into an object without an introducer. Temperature sensors 38a, 38b, 38c, and 38d detect temperature of meat 50 and provide information via lead 24 to hand held display unit 26. Display 42 indicates the temperature with buttons 44, 46, 48 being available to provide user control of the unit. Display unit 26 has a processor to select the lowest temperature value returned from 38a, 38b, 38c, and 38d. Alternatively, the processor may return a highest value, display a plurality of temperatures, or provide a graphical output of a plurality of temperatures. As illustrated, 38c is placed in center 60 of meat 50 and would typically have the lowest temperature that most accurately measures the temperature of interest to a cook working with a grill or oven. The use of a plurality of temperature sensors in the probe thus compensates for inaccuracies in placement of the probe. In alternative embodiments, probe 22 has another temperature sensor (not shown) located in a portion of the probe that is not for introduction into the object but placed to detect a temperature around the object; such a sensor may be used to measure an ambient cooking temperature, e.g., as in an oven or grill.

The probe may be made of a substantially rigid material, e.g., stainless steel, or, alternatively, a nonrigid material may be used for application to liquids or soft gels. Metals or a temperature-resistant plastic (e.g., certain tetrafluroethylenes, neoprenes, kevlars, or silicones) may be used for the probe. One report has described a scientific laboratory apparatus with a number of sensors that gather heat data to indicate physiologic temperatures in a patient for scientific medical purposes; in this case, thermocouples were placed in a polyethylene tube that could be placed by use of an introducer, see Ducharme and Frim, in J. Appl. Physiol. 65(5): 2337-2342 (1988). Another scientific laboratory apparatus for measuring physiological temperature described microthermocouples placed in TEFLON tubing that required placement with an introducer, Saltin et al., J. Appl. Physiol. 25(6):679-688 (1968). Another scientific laboratory apparatus for measuring physiological temperatures had microthermocouples disposed in a needle sheath, Riggle et al., Cryobiology, 10:345-346 (1973). These systems were intended for laboratory medical studies and were not suited for use in a high temperature application, e.g., cooking.

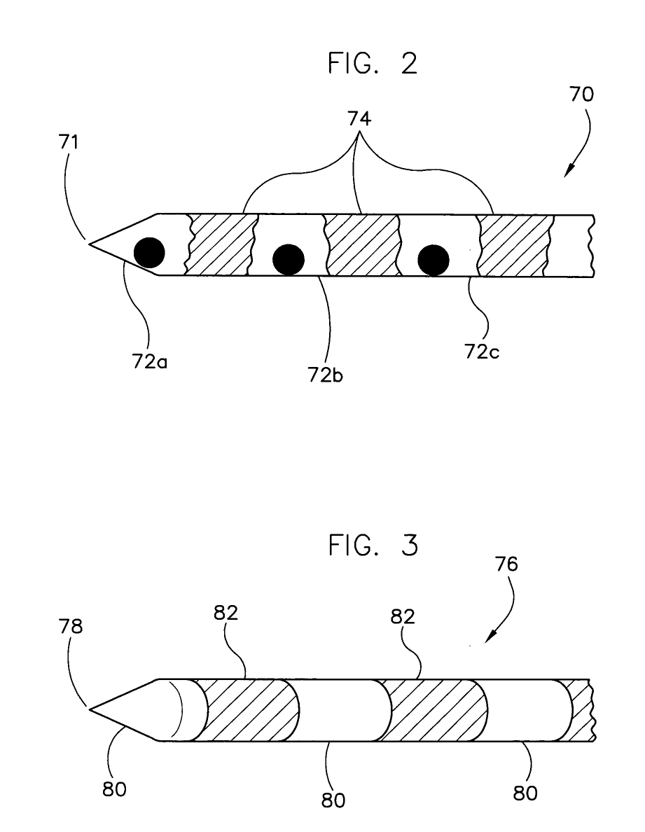

Some embodiments of a probe have insulation disposed inside the probe to reduce heat flow in the probe or between the sensors, for instance, the insulation may be placed between two temperature sensors, and would typically be entirely within the probe. FIG. 2 depicts a probe 70 having distal tip 71, with temperature sensors 72a, 72b, 72c separated by insulation 74. The insulation reduces flow of heat between the detectors to enhance measurement accuracy. Temperature sensors 72a, 72b, 72c are provided with wiring (not shown) as needed to return temperature data. In the case of thermocouples or thermistors, for example, two wires may be attached to each temperature sensor so as to test their electrical properties.

In general, a variety of insulators may be used with a probe, e.g., fibers, glasses, powders, beads, discs, insulating ceramics, insulating polymers, mineral wool, or natural materials. Thermal conductivity, λ, (lambda, measured in watts per meter per degrees Kelvin, W/mK) of a material represents the quantity of heat that passes through a meter thickness per square meter per time unit with one degree difference in temperature between the faces. The lower the lambda value, the better the insulator the material is. Approximate lambda values of typical materials are, for example (in W/mK): copper 380, beryllia (BeO) 248, aluminum 170-230; aluminum nitride 170, pure iron 80, steel 46; 1.0% carbon steel 43, alumina (AlO or Al₂O₃) 26, stainless steel 14-16, glass 2, zirconium oxide 1.8-2.7, clay bricks 0.8, silicone 0.2-0.8, typical plastic or wood 0.2, Kevlar 0.08, mineral wool 0.05, air 0.026, foamed plastic 0.02, glass wool 0.04, mineral wool 0.04. In general, a material is defined as insulating herein if its thermal conductivity is less than about 0.1 W/mK. In general, a material is defined as conducting herein if it has a lambda of more than about 10 W/mK. Some embodiments, however, are described in terms of materials that are insulating or conducting as compared to other materials.

As set forth in U.S. Pat. No. 7,120,478 insulators may include fiber materials or foaming materials having voids, or micro dust layer materials; such materials may be employed as insulators. In the case of fiber materials, glass wool, or materials having fiber properties similar thereto may be used, and the heat conductivity thereof may be, for example, from about 0.0005 W/mK to about 0.1 W/mK, or less than about 0.1 W/mK. In the case of foaming materials, polyurethane, polystyrene, or materials having properties similar to foaming material may be used. Moreover, in the case of micro dust layer materials, perlite, silica aerogel, or materials having the properties similar to micro dust layer material may be used, for example, and the heat conductivity thereof may be, for example, from about 0.0005 W/mK to about 0.1 W/mK, or less than about 0.1 W/mK.

Some embodiments using insulating materials inside an outer sheathing have the insulating materials disposed between at least two of the temperature sensors, or between each temperature sensor. Such insulation is typically placed between at least two of the temperature sensors to reduce the flow of heat between the sensors. Insulation that is not intentionally placed is generally ineffective to reduce flow of heat between sensors.

A probe with an outer sheathing that comprises a rigid portion, or that is entirely rigid, can advantageously be used to introduce the probe into an object by applying force to the rigid portion. Further a rigid portion can protect the probe from external forces that may tend to damage the probe. A rigid material thus requires adequate mechanical strength to resist denting in normal use, and thus excludes a substantially flexible material, e.g., a thin polyethylene tube. Further, a pointed end on the sheathing can also assist in introducing the probe into an object, e.g., user forcing a hand-held probe into the object. The outer sheathing or sheath refers to a shell that encases the temperature sensors; wires to the sensors come to the end of the outer sheathing and connect to an interface, or pass out of the sheathing. A bundle or connector may connect to the end of the probe to communicate with the wires in the probe. With respect to meat thermometers, outer sheathing typically takes the form of a hollow metal tube or tine of stainless steel with a pointed tip. A probe may have an outer sheathing that is exposed to temperatures in a grill or oven and also other parts; for instance, a fork may have tines with a certain outer sheathing and other materials for the handle or at the junction of the tines.

Some embodiments are thermometers or probes that are shatterproof, meaning that they are made only of materials that do not shatter when dropped or subjected to a sharp blow by a user; glass, for instance can be shattered, as well as certain brittle polystyrenes. Other embodiments of probes or thermometers are free of glass materials, with glass referring to the familiar silica-based material used for windows, containers and decorative objects, or comparable materials. A probe that is shatterproof has safety advantages in many applications, including medical or cooking applications. Some embodiments of the probe have heat insulating or heat conducting portions disposed at the probe's outer sheathing, e.g., integral to the sheath.

FIG. 3 depicts probe 76 with distal tip 78 having both heat-conductive outer sheathing 80 and heat-insulating outer sheathing 82. Heat-conductive portions 80 may overlay temperature sensors and heat-insulating portions may overlay areas without temperature sensors. When used in combination with the embodiment of FIG. 2, heat conductive portions 80 may overlay temperature sensors 72a, 72b, 72c, and heat insulating portions 82 may overlay insulation 74. The outer sheathing portions 80, 82 may be a coating or form part of full-thickness portion of probe 76. In some embodiments, probe 76 is made of a first material with a coating of heat-conducting material 80 and/or heat-insulating material 82.

In some embodiments the outer sheathing heat conducting portions are a base material, e.g., stainless steel. The outer sheathing base material may be combined with insulating materials, conductive materials, relatively more conductive heat conducting materials, or relatively less heat conductive materials. For instance, aluminum may be used as a relatively more heat conductive material as compared to a stainless steel base. Or a heat insulating portion, e.g., glass or silicone may be used. The heat conductive portions or heat insulating portions may overlay an outer sheathing made of the base material, e.g., stainless steel, or may be integral with the outer sheathing, e.g., silicone, Kevlar, or aluminum welded or screwed into stainless steel members or, alternatively, silicone or a temperature-resistant plastic overmolded on the outer sheathing. The outer sheathing may, for instance, have a temperature-resistant insulating plastic grip that allows a user to grip the probe soon after it has been exposed to cooking temperatures; the grip cools quickly so a user may handle it with bare hands even though the rest of the probe is still extremely hot. Examples of such materials are insulating materials with a melting point of more than 300° C., e.g., silicone or Kevlar.

Certain embodiments are probes with an outer sheathing made of materials with a melting point (in ° C.) of at least about 300, about 400, about 500, about 600, about 1000, or about 1300. Such an outer sheathing may further have a grip portion attached to it that has a different melting point. Cooking conditions are often in the range of about 200 or about 250° C.; while the temperature of a heating element of an oven or a flame may be higher, the temperature in the cooking portion of the oven or grill is seldom more than about 260° C., so that materials that maintain their physical properties up to this temperature may be used, with the material's melting point being an indicator of its useful range of temperature exposure. Stainless steels typically melt at about 1400° C., while other materials have meting points (in ° C.) of about: 120 for polyethylene, 220 for nylon, 240 for polystyrene, 270 for polycarbonate, 360 for silicone, 400 for Kevlar, 660 for aluminum, and 1000 for copper.

Temperature probes will typically have an outer sheathing with sensors disposed inside the outer sheathing. Electrical sensors are connected to wires that must ultimately communicate with a processor to read data from the sensors. In some embodiments, the wires terminate at a connector the end of the outer sheathing, with the connector being connectable to a wiring that will ultimately pass the electrical signal from the sensors to the processor, possibly through other intervening systems. In the case of thermometers used in a high temperature environment, e.g., an oven or grill, the wiring outside of the sheathing must have shielding adequate to withstand normal operating temperatures. In some embodiments, such wiring is shielded to withstand temperatures (in ° C.) of at least 100, 200, 250, 300, or 400. Thermal shielding processes are known to artisans in this technical field. Moreover, suitable steps must be taken for the wiring inside the sheathing as well. For instance, the melting point of most lead-free commercial solders is within the range of 210° to about 230° C., while tin-and-lead solders have a melting point of about 180° C. Such soldering must be protected with a suitably designed outer sheathing if the probe is to be operate din a high temperature environment. Moreover, the choice of electronic temperature sensors is dependent on the intended operating temperature of the thermometer since the accuracy of such sensors depends on the temperature that is being measured.

Some embodiments use electrically conductive plastics, e.g., wires, for connecting to a temperature sensor. A plastic wire conducts much less heat than a copper wire and can enhance the reliability and accuracy of the probe. Examples of conductive plastics are polythiophenes, polyparaphenylenes, and polyanilines. Such plastics are beneficial for electronic thermometers that have one or more temperature sensors.

Probes may be chosen with a length suitable to the application. Probes may be sized to reflect a particular application, e.g., cooking chops on a grill, cooking large meats such as a roast, or sampling a side of beef in a smokehouse. Exemplary probe lengths are 1-100 cm, and all ranges and values therebetween, e.g., 1, 2, 3, 4, 5, 2-10, 2-20, less than 100, and 5-15. Probes may be provided in any of a variety of geometries, including disposition in another device, e.g., in a tine of a fork. Discrete temperature sensors may be placed in a probe with a spacing that is, for example, substantially linear relative to each other (in-a-row), equidistant, at predetermined distances relative to a probe distal tip, placed so that a single continuous curve traced within the probe may intersect every detector without crossing itself (e.g., in-a-row, in a curved row, in a helix, but in this example not in separate tines of a conventional fork with at least three tines).

Sensors may be placed in a tine of a temperature probe. Many temperature probes have a single tine in the shape of a single tube with a pointed end. A probe having a tine is thus a probe with one tine, or more than one tine. Some temperature probes have two or more tines, as in a fork with a temperature sensor in one tine. The tine has an outer sheathing suited to the application. The temperature sensors may be arranged in an array in one tine. An array is a grouping of objects arranged in a row and/or column, and may be described as row x column. A linear array is a single row or a single column, thus three sensors in a single row would be a 1×3 linear array and five sensors in a single column would be a 5×1 linear array. The sensors in an array are arranged at known positions, e.g., certain distances from a tip of a probe or relative to each other so that information taken from the sensors can be interpreted in light of the relative positions of the sensors. Thus an array in a tine can be configured to measure a temperature gradient, which is a rate of change of temperature with respect to distance to a fixed point, e.g., the distal tip of the tine. An array of sensors in a single tine can be part of a probe with a tine or more than one tine. information taken from the sensors can be interpreted in light of the relative positions of the sensors. Thus an array in a tine can be configured to measure a temperature gradient, which is a rate of change of temperature with respect to distance to a fixed point, e.g., the distal tip of the tine. An array of sensors in a single tine can be part of a probe with a tine or more than one tine.

In some embodiments the probe and/or thermometer system is designed to have a plurality of temperature sensors and to have a single point of entry into the object, e.g., a rod-shaped probe with a pointed tip, but not a fork or a device with a plurality of tines. A probe with a plurality of temperature sensors may serve as a housing for the detectors. In certain embodiments the temperature sensors are sealed inside the probe, or sealed such that no water may enter the probe to contact the detector.

Some embodiments are directed to producing a temperature profile over a particular distance, with the choice of the number of temperature sensors driving the resolution of such a profile. Accordingly, embodiments include probes with a predetermined number of sensors, e.g., about 2 to about 20 temperature sensors, disposed over a predetermined distance, e.g., from about 2 to about 20 cm, with each probe at a predetermined position whereby a profile of temperature over a distance may be measured. In some embodiments, at least some of the sensors are placed within a predetermined distance of the distal tip of the prone, with the distal tip being the furthermost end of the probe put into an object and a proximal end of the probe being the end customarily grasped by a user during normal use when placing the probe. The predetermined distance may be, e.g., within about 2 to about 20 cm, e.g., within 2, 4, or 6 cm. Artisans will immediately appreciate that every range and value within the explicitly

Ceramics are also available for use in some or all of the probe, or as a coating that forms a layer on at least a portion of the probe. The properties of the material are chosen to be suitable to the application, e.g., food-grade for food temperature measuring applications, heat resistant for cooking applications, corrosion resistant for corrosive applications. Examples of ceramics include aluminas, zirconias, sapphire, silicon carbide, silicon nitride, macor, steatite, and quartz. Ceramics may be used, for instance, as conducting or insulating materials, as guided by their physical properties. Non-stick coatings may be used on the probe, including in combination with any of these embodiments, e.g., a polytetrafluoroethylene coating.

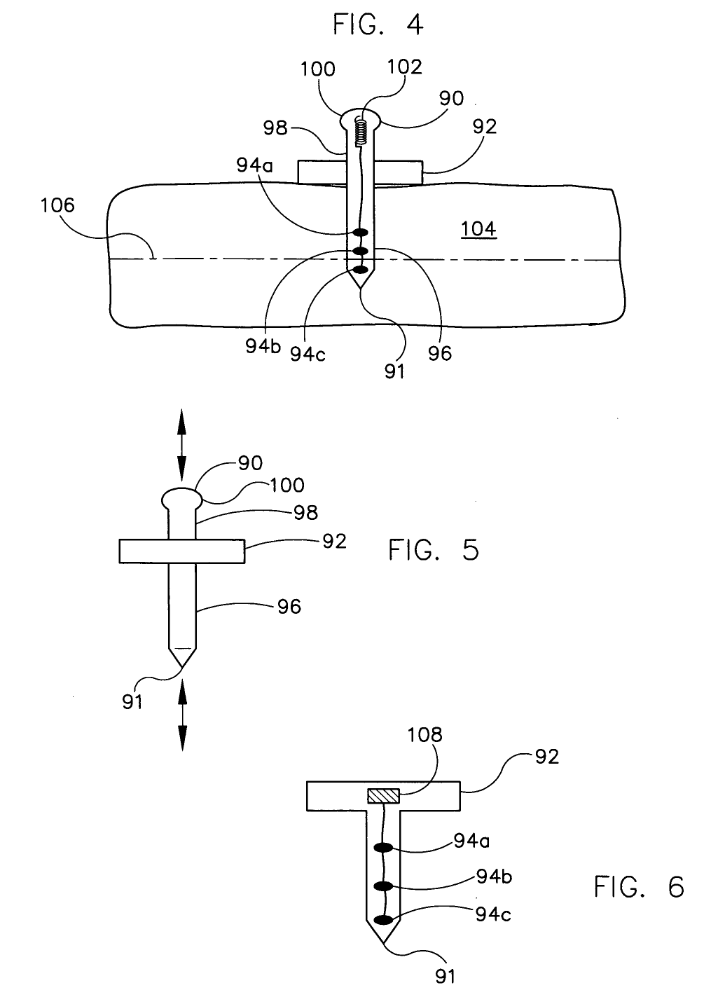

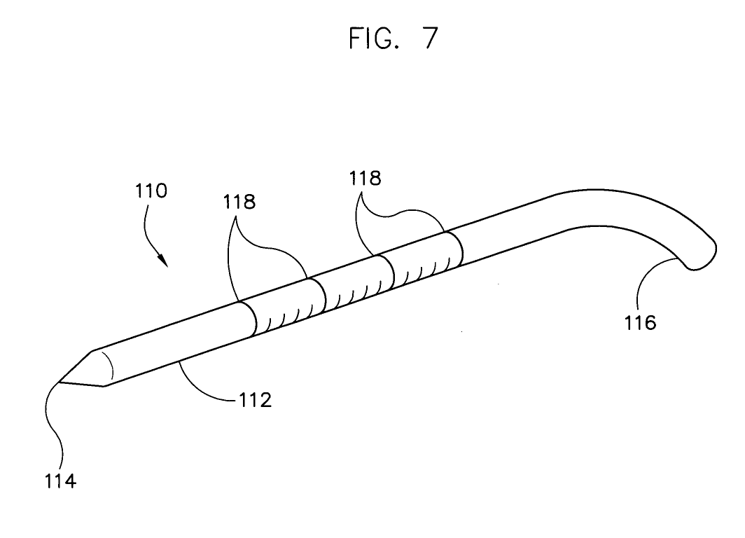

FIGS. 4 and 5 depict an alternative embodiment of a probe. Probe 90 is movable in base 92 and has temperature sensors 94a, 94b, 94c disposed in distal portion 96 of probe 90. Proximal portion 98 of probe 90 has stop 100. Transmitting coil 102 is disposed in probe 90 to transmit information from the temperature sensors to a receiving unit (not shown). In use, probe 90 is placed onto a piece of meat 104 and its distal tip is pushed therein. The user positions the probe until it is judged to have its distal tip 91 at a point that passes the midline 106 of meat 104. The user can appreciate that the probe has multiple temperature sensors and will return a value from a point near midline 106 so long as the distal tip is placed at least a short distance beyond the midline.

Alternatively, the probe may have a base with a distal probe portion extending from the base, as in FIG. 6, wherein base 92 has unit 108 for transmitting temperature-related information or circuitry to select the high or low temperature in detectors 94a, 94b, 94c and direct that information to a display, e.g., that is remote (wireless transmission) or on the base (e.g., a digital or analog temperature display). In certain

Alternatively, the probe may have a base with a distal probe portion extending from the base, as in FIG. 6, wherein base 92 has unit 108 for transmitting temperature-related information or circuitry to select the high or low temperature in detectors 94a, 94b, 94c and direct that information to a display, e.g., that is remote (wireless transmission) or on the base (e.g., a digital or analog temperature display). In certain embodiments, the probe has a predetermined length for use with common thicknesses of meats, or is provided as a set of probes with a selection of lengths. Examples of such probe lengths are 1-10 cm, e.g., 1, 2, 3, 4, 5, 6, 7, 8, 9, or 10 cm.

FIG. 7 depicts an embodiment of a probe having length indicia that a user may consult to determine the distance of the distal tip of the probe from the surface of the object that is probed. Probe 110 has distal portion 112 with distal tip 114 and proximal portion 116. Length indicia 118 indicate a distance from distal tip 114 to the indicia mark. Examples of such lengths are 1-10 cm, e.g., 1, 2, 3, 4, 5, 6, 7, 8, 9, or 10 cm. In use, a user inserts probe 110 into an object and observes the indicia 118 at the surface of the object to determine the distance of the distal tip 114 from the surface.

The probe may be part a simple rod with a pointed end, as depicted in FIG. 6, or may be part of a larger object such as a fork or rotisserie. In the case of a rotisserie, for example, the sensors may be disposed at a plurality of predetermined positions, so that multiple temperatures may be measured. The sensors may be disposed in a single probe, which may be, for example, linear over the portion having at least two of the sensors, or in multiple probes.

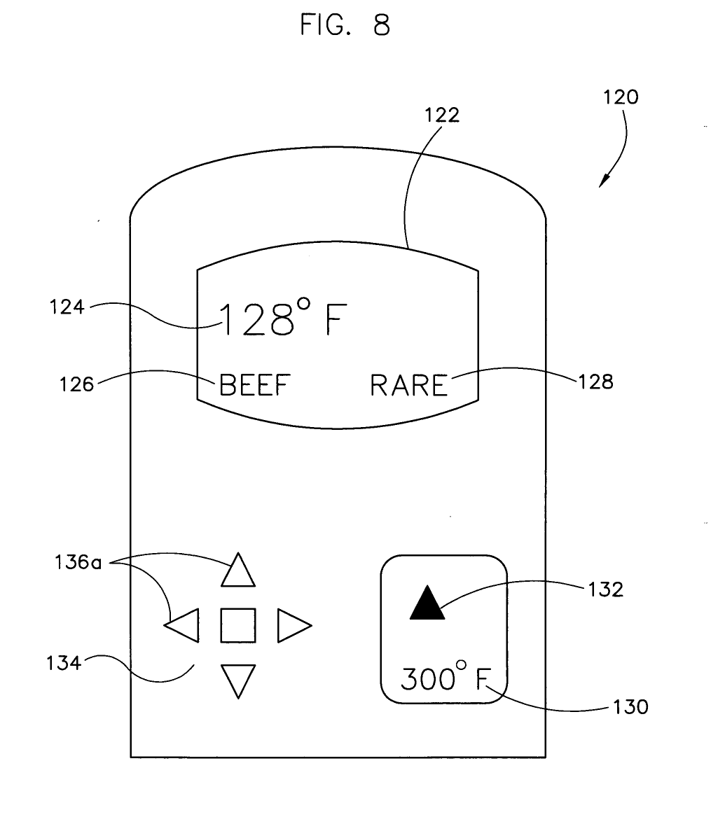

FIG. 8 depicts an example of a hand-held display unit. Display unit has display 122 that displays temperature field 124, object field 126, cooking option field 128, object, e.g., type of meat, cut of meat (e.g., chop, roast, whole bird), and to select a desired level of doneness (e.g., rare, medium rare), with such options being shown in fields 126, 128. In general, such inputs are stored in the device to create a predetermined value that can later be used to compare to measured temperatures, e.g., to activate an alarm when a predetermined value is reached. Alternatively, predetermined values can be captured by asking the user to input them directly.

In certain embodiments, a thermometer system further receives input from another temperature sensor or sensors that measure ambient temperature around the object; for example, an oven thermometer provides an input indicating temperature inside the oven or grill. Alternatively, the ambient temperature sensor may be located in a proximal portion of the probe that is intended to remain outside of the object and in the ambient cooking environment. Such information may be displayed at field 132, as in FIG. 8. Processors interacting with display unit 120 may use such information to generate suggestions for adjusting the temperature, as in arrowhead at field 132, indicating a suggested increase in ambient temperature. Such indications may be based on a general algorithm or incorporate input from the user. Optional features include one or more of: timers, count-down timers with an optional alarm, count-up timers with an optional alarm, activation of a remote alarm for paging purposes, or heat set points (e.g., controller beeps when preset temperature is achieved).

Alternatively, the processor may be used to display one or more temperatures in the probe. The processor may also use temperature data inputs to calculate a temperature profile for the object and optionally further direct a display to provide indicia to the user to take action. For example, in the context of cooking, the display may indicate that the profile is too steep so that the cooking temperature should be reduced, or indicate that the profile is too flat so that the cooking temperature should be increased. The processor may optionally use the profile or time-stored temperature data to project a cooking time, and direct a display to indicate the time remaining to reach a predetermined temperature or level of doneness. In some embodiments, ambient temperature information is processed with the temperature profile (over time or across a length of the probe, or both) to generate suggestions for adjusting the ambient temperature. In some embodiments, an alarm (e.g., audible, vibrating, talking, or paging the user) is generated to suggest adjustments to the ambient temperature and/or to indicate that the desired temperature is reached or will be reached in a desired amount of time. A series of alarms may be provided before, at, or after a desired temperature or predetermined temperature is reached, e.g., at five minutes until completion, at completion, at two minutes after completion. Other embodiments include a display that provides a temperature profile of the meat, e.g., temperature versus depth. Certain of these embodiments relate not only to achieving a particular temperature but advantageously track the rate at which a temperature is approached, allowing for adjustments to ambient cooking temperatures be made to achieve a desired rate, bearing in mind that a slower rate of cooking can sometimes provide a more tender meat while minimum meat temperatures are needed for efficiency or optimal food safety. Such processes are particularly advantageous with respect to cooking times of several hours, e.g., as in a smoker.

Temperature data from a plurality of sensors can be compared by a processor that outputs a result of the comparison to a display or another device, e.g., a hand-held unit. The output may be provided by direct electronic connection or other suitable means, e.g., wireless communication. The sensors may be in direct communication with the processor or indirectly connected by other suitable means, for instance, by passing through intermediate subcomponents, other devices or by wireless transmission. Comparing measured temperatures with each other refers to a logical operation performed on measured temperature data that requires comparing/contrasting. Examples of such operations are: determining the highest or lowest measured temperature, or distinguishing a measured temperature from a temperature in an object from ambient measured temperature. In contrast, a processor that merely interprets data from an electronic sensor to calculate a temperature or to apply a correction algorithm to a sensor is not comparing that temperature; nor is a processor that compares a measured temperature to a predetermined value comparing measured temperature data. Displaying a plurality of temperatures on a display for the user to compare is not using a processor for comparing measured temperatures.

Besides comparing measured temperature data, a processor may be configured to perform other operations, e.g., determining if a temperature exceeds a predetermined (e.g., user-inputted or table look-up) value to activate an alarm. In general, a plurality of temperature sensors are configured to measure distinct positions on a probe, and not the same spot on a probe, and sensors placed at distinct positions will accomplish the same. A processor may compare measured temperatures with each other to determine which temperatures are within the object that is being measured; in general, but depending on the application, a temperature that is much higher than the other temperatures indicates that the temperature relates to the ambient environment. In the case of a cooking thermometer, for instance, the processor may be programmed to identify the highest temperature as the temperature of the oven or grill, and other temperatures close to that as also being ambient temperatures, e.g., within 5% or 10%. The other temperatures could then be identified as being within the object. Thus comparing measured temperatures within the cooking object may require determining which temperatures are likely to be within the object, if necessary, given the probe design.

The highest or lowest temperature measured by the probe can be selected for display by connecting each temperature sensor into a processor that compares each value and returns the value that is highest or lowest. The term processor refers to a logical circuit or a microprocessor or software or firmware, a processor may, e.g., use or display data from a sensor or manipulate it. Thus the comparison could be done with hardware and/or software in a microprocessor-based device that can compare the values and provide the lowest value to the temperature display device. For example, a cooking thermometer may display the lowest temperature measured in a probe by each of a plurality of thermistors or other temperature sensors that each separately return a temperature either automatically, at a predetermined time, or in response to a query from the microprocessor. A processor evaluates each temperature and determines which temperature is the lowest temperature in the food. For instance, thermistors may be placed in a distal end of a thermometer probe and the lowest measured temperature value displayed. Alternatively, input from some or all of the thermistors may be used in an algorithm for estimating a temperature to be displayed. A plurality of temperature sensors or thermistors may be used, e.g., 2, 3, 4, 5, 6, 7, 8, 9, or 10, or more. In other embodiments, the lowest temperature is displayed instead of the highest temperature.

Some embodiments are directed to indicating on a display the lowest or highest measured temperature, or both. Indicating, in this particular context, refers to pre-identifying that value for the user. Thus, for example, only the lowest or highest measured temperature could be displayed. Or multiple temperatures could be displayed with the lowest value being indicated by larger font numbers, flashing, an arrow, the word “lowest” appearing, and so forth.

Embodiments are directed to using a thermometer to obtain measurements that indicate a temperature profile of an object. In some embodiments, a plurality of temperature sensors are disposed in a single probe and the thermometer displays at least two temperature sensor temperatures to establish a line that represents a profile through the tested portion of the meat. In use, a user places the probe into the object with the probe traversing the portion of the object for which a profile is desired, e.g., from a surface to a center, or completely through an object. A simple profile can be generated by displaying the temperatures at each detector, or such a display may be a chart or graph, e.g., temperature versus distance. Such calculations and displays may use the temperature data as determined at each sensor or may incorporate suitable curve-fitting algorithms.

Thus certain embodiments are directed to calculating a rate of cooking. The rate of cooking may be calculated using temperature inputs from a probe having one or more temperature sensors. The rate of cooking may also be projected by calculating the time left to complete the cooking process. The ambient temperature of the object may be measured. One or more of such inputs may be used to calculate and generate suggestions for changing an ambient temperature of the object being cooked. Or the calculation may be simply performed by extrapolating from historical temperature data collected over the time of the cooking process (e.g., linearly or by curve-fitting) or more complex algorithms may include empirical or modeled data in such processing. U.S. Pat. No. 7,102,107 describes certain time-based algorithms that may be used as part of such calculations.

Applications for the thermometer may include cooking, e.g., cooking on a grill, on a stove, or in an oven. The object to cook may include flat cuts such as steak or chops and larger objects such as turkeys or roasts. Other applications include warming or defrosting a food object, such as meat, food, casseroles, or frozen dinners; in these applications the minimum temperature continues to be significant to indicate a state of being defrosted or warmed. The use of a thermometer to calculate and/or display a temperature profile (over time or over distance or both) is particularly useful since partial cooking during warming or defrosting is a recurring problem in home and commercial food preparation. For instance, the thermometer system could provide an alarm, an electronic signal output to a controlling device or display device, or other indication when temperature measurements indicate unwanted cooking or warming is taking place, or is projected to take place within a predetermined time. In certain embodiments the temperature sensors could advantageously be placed in both proximal portions and distal portions of the probe, or placed all along the probe at predetermined distances, or equidistantly to facilitate calculations.

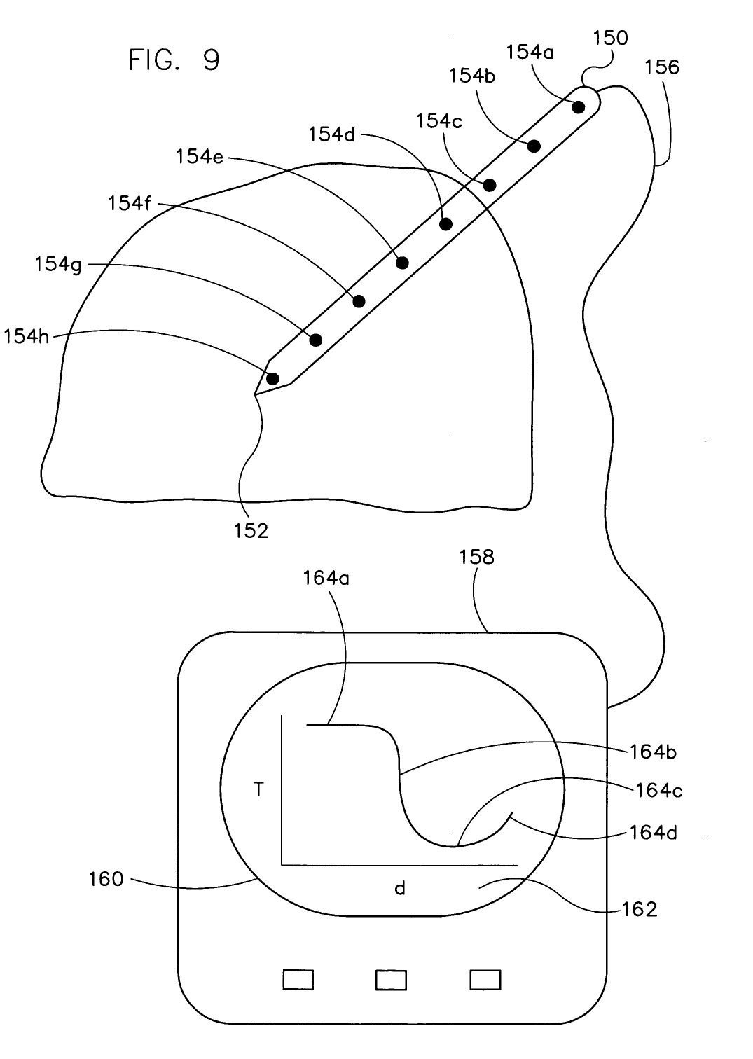

FIG. 9 shows an embodiment with probe having distal tip 152 and temperature sensors 154a -154h that provide information via leads 156 to display unit 158 having display 160 showing graph 162 of temperature versus distance. Graph 162 has an exemplary temperature profile 164a showing a high ambient temperature (as in defrosting or warming), a relatively warmer temperature in the exterior object portions 164b, a minimal temperature at the approximate center 164c and a higher temperature 164d at a detector that is located beyond the cool center.

Further, certain embodiments are related to a thermometer system comprising a temperature probe that comprises a plurality of temperature sensors that each measure a separate temperature of a distinct portion of the probe. Certain embodiments include probes that have between 2 and 10 thermistors, or between 2 and 20 temperature sensors, including all values and ranges therebetween, e.g., 2-10, 2-8, 3-10, or 3-20. Certain embodiments involve using the measured temperatures to calculate or model a temperature distribution in an object, and optionally display results of the same, e.g., graphically, by chart, or in a tabular fashion, e.g., with the temperatures being shown at predetermined distances. Methods include using such devices by placing a temperature probe into an object, obtaining temperature data for at least two distinct points of the probe (or the object at the point next to the probe), processing the temperature data, and displaying at least one of the temperatures, wherein the probe comprises at least two temperature sensors to obtain the temperature data. Some embodiments capture the lowest temperature or highest temperature measured in an object while other embodiments generate and/or display temperature profiles for the object that is being probed.

Accordingly, certain embodiments are related to a thermometer system comprising a temperature probe that comprises a plurality of temperature sensors that each measure a separate temperature of a distinct portion of the probe. Certain embodiments include probes that have between 2 and 10 thermistors, or between 2 and 20 temperature sensors, including all values and ranges therebetween, e.g., 2-10, 2-8, 3-10, or 3-20. Certain embodiments involve using the measured temperatures to calculate or model a temperature distribution in an object, and optionally display results of the same, e.g., graphically, by chart, or in a tabular fashion. Methods include using such devices by placing a temperature probe into an object, obtaining temperature data for at least two distinct points of the probe (or the object at the point next to the probe), processing the temperature data, and displaying at least one of the temperatures, wherein the probe comprises at least two temperature sensors to obtain the temperature data. Some embodiments capture the lowest temperature measured in an object while other embodiments generate and/or display temperature profiles for the object that is being probed.

Embodiments of a probe for a thermometer system include: a temperature probe that comprises an outer sheathing (optionally with a melting point of at least 300° C.) that contains a plurality of electronic temperature sensors disposed to measure temperature at distinct portions of the probe. Such a probe may free of glass materials and comprise a pointed tip. The probe may be built to be suitable for a cooking thermometer, with a rigid outer sheath, a pointed tip, and a suitable melting point, e.g., more than 300° C. The probe may have and at least one temperature sensor disposed on the probe in a position for measuring an ambient temperature of an object being cooked. The probe may have insulation within the outer sheathing disposed between two temperature sensors to reduce heat flow in the probe between the two temperature sensors. The outer sheathing itself may comprise an insulating material.

While many embodiments are directed to cooking, the thermometers may be applied to other applications. Similarly, while many embodiments are directed to warming, the thermometers can be applied to situations wherein cooling is desired. Moreover, while many embodiments are directed to measuring solid objects, the temperatures or temperature profiles may be obtained for a liquid or semisolid. In general, the features for each embodiment herein may be mixed-and-matched with features from other embodiments as guided by requirements for making a functional device. All patents, patent applications, and publications mentioned herein are hereby incorporated by reference to the extent that they do not contradict the explicit disclosure of this patent application.

1. A thermometer system comprising:
a hand-held temperature probe that comprises a pointed tine made of an outer sheathing material with a melting point of at least 300° C., the tine containing a plurality of electronic temperature sensors disposed in a linear array to measure temperature at distinct portions of the tine;
a processor for comparing the measured temperatures with each other; and
a hand-held unit to display at least one of the measured temperatures after comparing the measured temperatures with each other.

2. The thermometer system of claim 1 further comprising temperature shielded wiring connected to the probe, with the shielded wiring withstanding a temperature of at least 250° C.

3. The thermometer system of claim 1 wherein the temperature sensors are thermistors.

4. The thermometer system of claim 1 wherein the temperature sensors are between three and ten in number.

5. The probe of claim 1 further comprising insulation within the outer sheathing and disposed between two of the plurality of temperature sensors to reduce heat flow in the probe between the two temperature sensors.

6. The thermometer system of claim 1 wherein the display indicates at least three temperatures taken at distinct portions of the probe.

7. A method of obtaining a temperature using a self-inserting temperature probe, comprising:
inserting the self-inserting temperature probe into an object, with the tine having an outer sheathing made from material with a melting point of at least 300° C.;
heating the object with an external energy source;
measuring temperatures within the heated object at distinct positions of the tine with a plurality of electronic temperature sensors disposed as a linear array in the tine; and
comparing the measured temperatures with each other using a processor that outputs a result of the comparison to a display on a hand-held unit.

8. The method of claim 7 wherein displaying the processed temperature data on the display comprises indicating on the display the lowest measured temperature.

9. The method of claim 7 further comprising providing an alarm when the lowest measured temperature is at least the value of a predetermined temperature.

10. The method of claim 7 wherein the probe comprises insulation between at least two of the temperature sensors to reduce the flow of heat between the sensors.

11. The method of claim 7 further comprising connecting the probe with wiring shielded to withstand a temperature of at least 250° C.

12. A method of claim 7 wherein the object is a food item and heating the object with an external energy source comprise cooking the food item.

13. A method of making a thermometer for measuring temperatures within an object comprising placing a plurality of electronic temperature sensors in a linear array in a temperature probe tine having an outer sheathing with a melting point of at least 300° C., and connecting the probe to wiring shielded to withstand a temperature of at least 250° C.

14. The method of claim 13 further comprising connecting the sensors to a processor that compares temperature data measured by the plurality of sensors and outputs a result of the comparison to a display on a hand-held unit.

15. The method of claim 13 comprising placing insulation between at least two of the temperature sensors to reduce the flow of heat between the sensors.
